(19) United States
(12) Patent Application Publication
(10) Pub. No.: US 2024/0062322 A1
(43) Pub. Date: Feb. 22, 2024

(54) PROPERTY TOUR MANAGEMENT SYSTEMS

(71) Applicant: AboutTimeTours, LLC, Bend, OR (US)

(72) Inventors: Matthew Donald McCoun, Bend, OR (US); Christopher Dean Mergenthaler, Hobe Sound, FL (US)

(21) Appl. No.: 18/173,711

(22) Filed: Feb. 23, 2023

Related U.S. Application Data
(60) Provisional application No. 63/313,108, filed on Feb. 23, 2022.

(51) Int. Cl. G06Q 50/16

(52) U.S. Cl. CPC G06Q 50/163

(57) ABSTRACT

Property Tour Management Systems (PTMS) of the present disclosure may include a PTMS application running on a network that includes multiple mobile digital devices and one or more servers. Each of the mobile digital devices may be used by respective agents or prospective buyers to carry out one or more procedures associated with property tours.

### CROSS-REFERENCE TO RELATED APPLICATIONS

This application claims the benefit of U.S. Provisional Patent Application No. 63/313,108, which was filed on Feb. 23, 2022 and entitled “Real Estate Property Tour Management Systems.” The complete disclosure of the above application is hereby incorporated by reference for all purposes.

### FIELD

This disclosure relates to systems and methods for automating a property tour in which buyers visit and view multiple properties, such as real estate properties, on the same tour.

### INTRODUCTION

When real estate buying agents are working with their client buyers, they often conduct tours of various properties identified by the purchasers or the buying agent, attempting to tour several properties during the same trip. This process is currently complicated and inefficient. Buying agents must first identify the properties that they and their client buyers will visit on the tour. Next, buying agents must access the listing database within which the identified properties are listed to compile information for the buyer and for the agent (much of the information in the listing database is often confidential to protect property sellers' privacy and security).

Buying agents must then coordinate with each real estate listing agent who represents a property seller for the identified properties to determine when they and their buyers can access and tour the properties. This coordination is further complicated because buying agents and buyers may wish to optimize their route between the properties, but an optimal route may not be the shortest route geographically because of the availability of the properties.

Often, the buying agent and the buyer, if they are traveling separately from the buying agent, must open mapping software on their phones to identify the route between each property. The listing agent must notify the sellers when they should leave the property and when they can return to avoid interaction between the buyer and seller and so protect the anonymity of real estate agent representation. This may require the buying agent to coordinate with the listing agents again during the tour.

The process just described can take significant time, so there is need to simplify the real estate property touring process and reduce the burdens on listing and buying agents. The property tour management system (“PTMS”) described in the teachings below simplifies the touring process by automating many of the above steps.

### BRIEF DESCRIPTION OF THE DRAWINGS

FIG. 1 is a schematic diagram of various components of an illustrative data processing system suitable for use with aspects of the present disclosure.

FIG. 2 is a schematic representation of an illustrative computer network suitable for use with aspects of the present disclosure.

FIG. 3 is a flow chart depicting steps of an illustrative form of property tour management system that accepts information, creates a property tour schedule, and provides real-time feedback during a property tour.

### DETAILED DESCRIPTION

Various embodiments of the PTMS are described below and illustrated in the associated drawings. Unless otherwise specified, a PTMS of the present teachings, and/or its various components may, but are not required to, contain at least one of the structures, components, functionality, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

A “real estate buying agent” or just “buying agent” is a person or entity that represents the interests of a property buyer through the property identification and sale process.

A “real estate listing agent” or just “listing agent” is a person or entity that represents the interests of a property seller through the buyer identification and sale process. They list the properties for sale in databases such as a multiple listing service described below for buying agents to find.

A “multiple listing service” or “MLS” is a database or several databases that real estate professionals may use to share information about real estate listings with other real estate professionals. Some of the information in an MLS may not be publicly accessible, such as a seller's home address, personal information, or the times of day when a tour is permissible, to protect said seller's privacy, safety, and property.

### Overview

In general, a PTMS of the present disclosure may include a network-connected PTMS application running on multiple mobile digital devices (“MDDs”) (e.g., a smartphone). The PTMS application (sometimes called an “app”) may include functionality that enables buying agents to access information in a multiple listing service (“MLS”) (defined above), identify and mark properties to be added to a tour, schedule a tour in coordination with listing agents, optimize and map the tour route, and communicate with the buyer. The PTMS app may include functionality that enables property buyers to access non-confidential MLS information, identify and mark properties to be added to a later tour, view a map and tour route, and communicate with the buying agent. The PTMS app may also include functionality that enables a listing agent to coordinate a tour with the buying agent and provide feedback to the buying agent. It also may notify sellers and the listing agent when the buying agent and buyer are approaching or leaving the property for sale.

Aspects of the PTMS described herein may be embodied as a computer method, computer system, or computer program product. Accordingly, aspects of the PTMS may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the PTMS may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random-access memory (“RAM”), a read-only memory (“ROM”), an erasable programmable read-only memory (“EPROM” or “Flash memory”), an optical fiber, a portable compact disc read-only memory (“CD-ROM”), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, radio frequency, and/or the like, and/or any suitable combination of these.

Computer program code for carrying out operations for aspects of the PTMS may be written in one or any combination of programming languages, including an object-oriented programming language such as Java, Smalltalk, C++, and/or the like, and conventional procedural programming languages, such as C. Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (“LAN”) or a wide area network (“WAN”), and/or the connection may be made to an external computer (for example, through the Internet using an Internet Service Provider).

Aspects of the PTMS are described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s). In some examples, machine-readable instructions may be programmed onto a programmable logic device, such as a field programmable gate array (“FPGA”).

These computer program instructions can also be stored in a computer-readable medium that can direct a computer, other programmable data processing apparatus, and/or other device to function in a particular manner, such that the instructions stored in the computer-readable medium produce an article of manufacture including instructions which implement the function/act specified in the flowchart and/or block diagram block(s).

The computer program instructions can also be loaded onto a computer, other programmable data processing apparatus, and/or other device to cause a series of operational steps to be performed on the device to produce a computer-implemented process such that the instructions which execute on the computer or other programmable apparatus provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the PTMS. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

### A. Illustrative Data Processing System

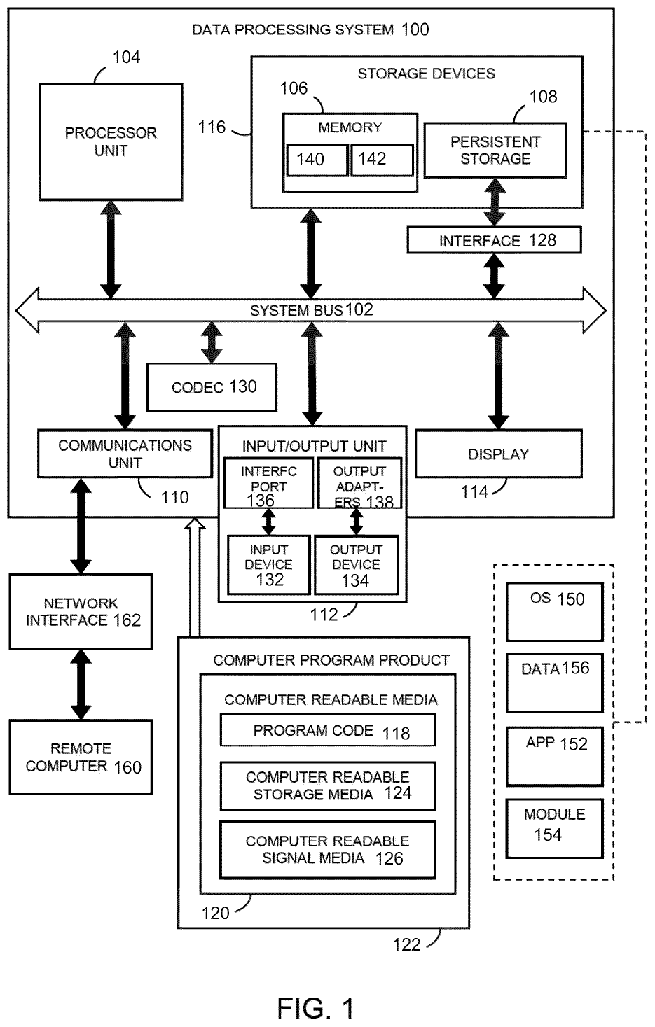

As shown in FIG. 1, this example describes a data processing system 100 (also referred to as a computer, computing system, and/or computer system) in accordance with aspects of the present disclosure. In this example, data processing system 100 is an illustrative data processing system suitable for implementing aspects of the PTMS. More specifically, in some examples, devices that are embodiments of data processing systems (e.g., smartphones, tablets, personal computers) may be used by one or more real estate listing or buying agents, buyers, and/or sellers. In other words, MDDs 112 may be examples of data processing systems. Further, devices that are embodiments of data processing systems (e.g., smartphones, tablets, personal computers) may be used as one or more server(s) in communication with one or more mobile communication devices.

In this illustrative example, data processing system 100 includes a system bus 102 (also referred to as communications framework). System bus 102 may provide communications between a processor unit 104 (also referred to as a “processor” or “processors”), a memory 106, a persistent storage 108, a communications unit 110, an input/output (“I/O”) unit 112, a codec 130, and/or a display 114. Memory 106, persistent storage 108, communications unit 110, I/O unit 112, display 114, and codec 130 are examples of resources that may be accessible by processor unit 104 via system bus 102.

Processor unit 104 serves to run instructions that may be loaded into memory 106. Processor unit 104 may comprise a number of processors, a multi-processor core, and/or a particular type of processor or processors (e.g., a central processing unit (“CPU”), graphics processing unit (“GPU”), etc.), depending on the particular implementation. Further, processor unit 104 may be implemented using a number of heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device may include any suitable hardware capable of storing information (e.g., digital information), such as data, program code in functional form, and/or other suitable information, either on a temporary basis or a permanent basis.

Storage devices 116 also may be referred to as computer-readable storage devices or computer-readable media. Memory 106 may include a volatile storage memory 140 and a non-volatile memory 142. In some examples, a basic input/output system (“BIOS”), containing the basic routines to transfer information between elements within the data processing system 100, such as during start-up, may be stored in non-volatile memory 142. Persistent storage 108 may take various forms, depending on the implementation.

Persistent storage 108 may contain one or more components or devices. For example, persistent storage 108 may include one or more devices such as a magnetic disk drive (also referred to as a “hard disk drive” or “HDD”), solid state disk (“SSD”), floppy disk drive, tape drive, Jaz drive, Zip drive, LS-80 drive, flash memory card, memory stick, and/or the like, or any combination of these. One or more of these devices may be removable and/or portable (e.g., a removable hard drive). Persistent storage 108 may include one or more storage media separately or in combination with other storage media, including an optical disk drive such as a compact disk ROM device (“CD-ROM”), CD recordable drive (“CD-R Drive”), CD rewritable drive (“CD-RW Drive”), and/or a digital versatile disk ROM drive (“DVD-ROM”). To facilitate connection of the persistent storage devices 108 to system bus 102, a removable or non-removable interface is typically used, such as interface 128.

Input/output (“I/O”) unit 112 allows for input and output of data with other devices that may be connected to data processing system 100 (i.e., input devices and output devices). For example, input device 132 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 104 through system bus 102 via interface port(s) 136. Interface port(s) 136 may include, for example, a serial port, a parallel port, a game port, and/or a universal serial bus (“USB”).

Output devices 134 may use some of the same types of ports, and in some cases the same actual ports, as input device(s) 132. For example, a USB port may be used to provide input to data processing system 100 and to output information from data processing system 100 to an output device 134. Output adapter 138 is provided to illustrate that there are some output devices 134 (e.g., monitors, speakers, and printers, among others) which require special adapters. Output adapters 138 may include, e.g. video and sounds cards that provide a means of connection between the output device 134 and system bus 102. Other devices and/or systems of devices may provide both input and output capabilities, such as remote computer(s) 160. Display 114 may include any suitable human-machine interface or other mechanism configured to display information to a user, e.g., a CRT, LED, or LCD monitor or screen, etc.

Communications unit 110 refers to any suitable hardware and/or software employed to provide for communications with other data processing systems or devices. While communication unit 110 is shown inside data processing system 100, it may in some examples be at least partially external to data processing system 100. Communications unit 110 may include internal and external technologies, e.g., modems (including regular telephone grade modems, cable modems, and DSL modems), ISDN adapters, and/or wired and wireless Ethernet cards, hubs, routers, etc. Data processing system 100 may operate in a networked environment, using logical connections to one or more remote computers 160. A remote computer(s) 160 may include a personal computer (“PC”), a server, a router, a network PC, a workstation, a microprocessor-based appliance, a peer device, a smart phone, a tablet, another network note, and/or the like. Remote computer(s) 160 typically include many of the elements described relative to data processing system 100. Remote computer(s) 160 may be logically connected to data processing system 100 through a network interface 162 which is connected to data processing system 100 via communications unit 110. Network interface 162 encompasses wired and/or wireless communication networks, such as local-area networks (“LAN”), wide-area networks (“WAN”), and cellular networks. LAN technologies may include Fiber Distributed Data Interface (“FDDI”), Copper Distributed Data Interface (“CDDI”), Ethernet, Token Ring, and/or the like. WAN technologies include point-to-point links, circuit switching networks (e.g., Integrated Services Digital networks (“ISDN”) and variations thereon), packet switching networks, and Digital Subscriber Lines (“DSL”).

Codec 130 may include an encoder, a decoder, or both, comprising hardware, software, or a combination of hardware and software. Codec 130 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 130 is depicted as a separate component, codec 130 may be contained or implemented in memory, e.g., non-volatile memory 142.

Non-volatile memory 142 may include read only memory (“ROM”), programmable ROM (“PROM”), electrically programmable ROM (“EPROM”), electrically erasable programmable ROM (EEPROM), flash memory, and/or the like, or any combination of these. Volatile memory 140 may include random access memory (“RAM”), which may act as external cache memory. RAM may comprise static RAM (“SRAM”), dynamic RAM (“DRAM”), synchronous DRAM (“SDRAM”), double data rate SDRAM (“DDR SDRAM”), enhanced SDRAM (“ESDRAM”), and/or the like, or any combination of these.

Instructions for the operating system, applications, and/or programs may be located in storage devices 116, which are in communication with processor unit 104 through system bus 102. In these illustrative examples, the instructions are in a functional form in persistent storage 108. These instructions may be loaded into memory 106 for execution by processor unit 104. Processes of one or more embodiments of the present disclosure may be performed by processor unit 104 using computer-implemented instructions, which may be located in a memory, such as memory 106.

These instructions are referred to as program instructions, program code, computer usable program code, or computer-readable program code executed by a processor in processor unit 104. The program code in the different embodiments may be embodied on different physical or computer-readable storage media, such as memory 106 or persistent storage 108. Program code 118 may be located in a functional form on computer-readable media 120 that is selectively removable and may be loaded onto or transferred to data processing system 100 for execution by processor unit 104. Program code 118 and computer-readable media 120 form computer program product 122 in these examples. In one example, computer-readable media 120 may comprise computer-readable storage media 124 or computer-readable signal media 126.

Computer-readable storage media 124 may include, for example, an optical or magnetic disk that is inserted or placed into a drive or other device that is part of persistent storage 108 for transfer onto a storage device, such as a hard drive, that is part of persistent storage 108. Computer-readable storage media 124 also may take the form of a persistent storage, such as a hard drive, a thumb drive, or a flash memory, that is connected to data processing system 100. In some instances, computer-readable storage media 124 may not be removable from data processing system 100.

In these examples, computer-readable storage media 124 is a non-transitory, physical or tangible storage device used to store program code 118 rather than a medium that propagates or transmits program code 118. Computer-readable storage media 124 is also referred to as a computer-readable tangible storage device or a computer-readable physical storage device. In other words, computer-readable storage media 124 is media that can be touched by a person.

Alternatively, program code 118 may be transferred to data processing system 100, e.g., remotely over a network, using computer-readable signal media 126. Computer-readable signal media 126 may be, for example, a propagated data signal containing program code 118. For example, computer-readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer-readable signal media 126 for use within data processing system 100. For instance, program code stored in a computer-readable storage medium in a server data processing system may be downloaded over a network from the server to data processing system 100. The computer providing program code 118 may be a server computer, a client computer, or some other device capable of storing and transmitting program code 118.

In some examples, program code 118 may comprise an operating system (“OS”) 150. Operating system 150, which may be stored on persistent storage 108, controls and allocates resources of data processing system 100. One or more applications 152 take advantage of the operating system's management of resources via program modules 154, and program data 156 stored on storage devices 116. OS 150 may include any suitable software system configured to manage and expose hardware resources of computer 100 for sharing and use by applications 152. In some examples, OS 150 provides application programming interfaces (“APIs”) that facilitate connection of different type of hardware and/or provide applications 152 access to hardware and OS services. In some examples, certain applications 152 may provide further services for use by other applications 152, e.g., as is the case with so-called “middleware.” Aspects of present disclosure may be implemented with respect to various operating systems or combinations of operating systems.

The different components illustrated for data processing system 100 are not meant to provide architectural limitations to the manner in which different embodiments may be implemented. One or more embodiments of the present disclosure may be implemented in a data processing system that includes fewer components or includes components in addition to and/or in place of those illustrated for computer 100. Other components shown in FIG. 1 can be varied from the examples depicted. Different embodiments may be implemented using any hardware device or system capable of running program code. As one example, data processing system 100 may include organic components integrated with inorganic components and/or may be comprised entirely of organic components (excluding a human being). For example, a storage device may be comprised of an organic semiconductor.

In some examples, processor unit 104 may take the form of a hardware unit having hardware circuits that are specifically manufactured or configured for a particular use, or to produce a particular outcome or progress. This type of hardware may perform operations without needing program code 118 to be loaded into a memory from a storage device to be configured to perform the operations. For example, processor unit 104 may be a circuit system, an application specific integrated circuit (“ASIC”), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (“FPGA”), and other suitable hardware devices. With this type of implementation, executable instructions (e.g., program code 118) may be implemented as hardware, e.g., by specifying an FPGA configuration using a hardware description language (“HDL”) and then using a resulting binary file to (re)configure the FPGA.

In another example, data processing system 100 may be implemented as an FPGA-based (or in some cases ASIC-based), dedicated-purpose set of state machines (e.g., Finite State Machines (“FSM”)), which may allow critical tasks to be isolated and run on custom hardware. Whereas a processor such as a CPU can be described as a shared-use, general purpose state machine that executes instructions provided to it, FPGA-based state machine(s) are constructed for a special purpose and may execute hardware-coded logic without sharing resources. Such systems are often utilized for safety-related and mission-critical tasks.

In still another illustrative example, processor unit 104 may be implemented using a combination of processors found in computers and hardware units. Processor unit 104 may have a number of hardware units and a number of processors that are configured to run program code 118. With this depicted example, some of the processes may be implemented in the number of hardware units, while other processes may be implemented in the number of processors.

In another example, system bus 102 may comprise one or more buses, such as a system bus or an input/output bus. Of course, the bus system may be implemented using any suitable type of architecture that provides for a transfer of data between different components or devices attached to the bus system. System bus 102 may include several types of bus structure(s) including memory bus or memory controller, a peripheral bus or external bus, and/or a local bus using any variety of available bus architectures (e.g., Industrial Standard Architecture (“ISA”), Micro-Channel Architecture (“MSA”), Extended ISA (“EISA”), Intelligent Drive Electronics (“IDE”), VESA Local Bus (“VLB”), Peripheral Component Interconnect (“PCI”), Card Bus, Universal Serial Bus (“USB”), Advanced Graphics Port (“AGP”), Personal Computer Memory Card International Association bus (“PCMCIA”), Firewire (IEEE 1394), and Small Computer Systems Interface (“SCSI”)).

Additionally, communications unit 110 may include a number of devices that transmit data, receive data, or both transmit and receive data. Communications unit 110 may be, for example, a modem or a network adapter, two network adapters, or some combination thereof. Further, a memory may be, for example, memory 106, or a cache, such as that found in an interface and memory controller hub that may be present in system bus 102.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the drawings. For example, the functions of two blocks shown in succession may be executed substantially concurrently, or the functions of the blocks may sometimes be executed in the reverse order, depending upon the functionality involved.

### B. Illustrative Computer Network/Distributed Data Processing System

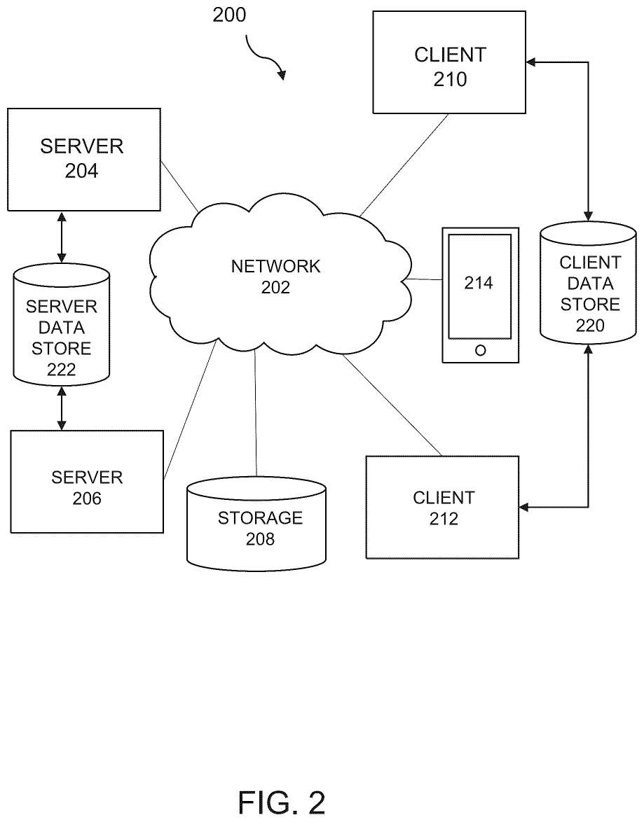

As shown in FIG. 2, this example describes a general network data processing system 200, interchangeably termed a computer network, a network system, a distributed data processing system, or a distributed network, aspects of which may be included in one or more illustrative embodiments of the PTMS described herein.

It should be appreciated that FIG. 2 is provided as an illustration of one implementation and is not intended to imply any limitation with regard to environments in which different embodiments may be implemented. Many modifications to the depicted environment may be made.

Network system 200 is a network of devices (e.g., computers), each of which may be an example of data processing system 100, and other components. Network data processing system 200 may include network 202, which is a medium configured to provide communications links between various devices and computers connected within network data processing system 200. Network 202 may include connections such as wired or wireless communication links, fiber optic cables, and/or any other suitable medium for transmitting and/or communicating data between network devices, or any combination thereof.

In the depicted example, a first network device 204 and a second network device 206 connect to network 202, as do one or more computer-readable memories or storage devices 208. Network devices 204 and 206 are examples of data processing system 100, described above. In the depicted example, devices 204 and 206 are shown as server computers, which are in communication with one or more server data store(s) 222 that may be employed to store information local to server computers 204 and 206, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 210 and 212 and/or a client smart device 214, may connect to network 202. Each of these devices is an example of data processing system 100, described above regarding FIG. 1. Client electronic devices 210, 212, and 214 may include, for example, one or more personal computers, network computers, and/or mobile computing devices such as personal digital assistants (“PDAs”), smart phones, handheld gaming devices, wearable devices, and/or tablet computers, and the like. In the depicted example, server 204 provides information, such as boot files, operating system images, and applications to one or more of client electronic devices 210, 212, and 214. Client electronic devices 210, 212, and 214 may be referred to as “clients” in the context of their relationship to a server such as server computer 204. Client devices may be in communication with one or more client data store(s) 220, which may be employed to store information local to the clients (e.g., cookie(s) and/or associated contextual information). Network data processing system 200 may include more or fewer servers and/or clients (or no servers or clients), as well as other devices not shown.

In some examples, first client electric device 210 may transfer an encoded file to server 204. Server 204 can store the file, decode the file, and/or transmit the file to second client electric device 212. In some examples, first client electric device 210 may transfer an uncompressed file to server 204 and server 204 may compress the file. In some examples, server 204 may encode text, audio, and/or video information, and transmit the information via network 202 to one or more clients.

Client smart device 214 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (“NFC”), BLUETOOTH®, WiFi, or mobile broadband networks. Wireless connectively may be established among smart devices, smartphones, computers, and/or other devices to form a mobile network where information can be exchanged.

Data and program code located in system 200 may be stored in or on a computer-readable storage medium, such as network-connected storage device 208 and/or a persistent storage 108 of one of the network computers, as described above, and may be downloaded to a data processing system or other device for use. For example, program code may be stored on a computer-readable storage medium on server computer 204 and downloaded to client 210 over network 202, for use on client 210. In some examples, client data store 220 and server data store 222 reside on one or more storage devices 208 and/or 108.

Network data processing system 200 may be implemented as one or more of different types of networks. For example, system 200 may include an intranet, a local area network (“LAN”), a wide area network (“WAN”), or a personal area network (“PAN”). In some examples, network data processing system 200 includes the Internet, with network 202 representing a worldwide collection of networks and gateways that use the transmission control protocol/Internet protocol (“TCP/IP”) suite of protocols to communicate with one another. At the heart of the Internet is a backbone of high-speed data communication lines between major nodes or host computers. Thousands of commercial, governmental, educational, and other computer systems may be utilized to route data and messages. In some examples, network 202 may be referred to as a “cloud.” In those examples, each server 204 may be referred to as a cloud computing node, and client electronic devices may be referred to as cloud consumers, or the like. FIG. 2 is intended as an example, and not as an architectural limitation for any illustrative embodiments.

### C. Illustrative Property Tour Management System (“PTMS”)

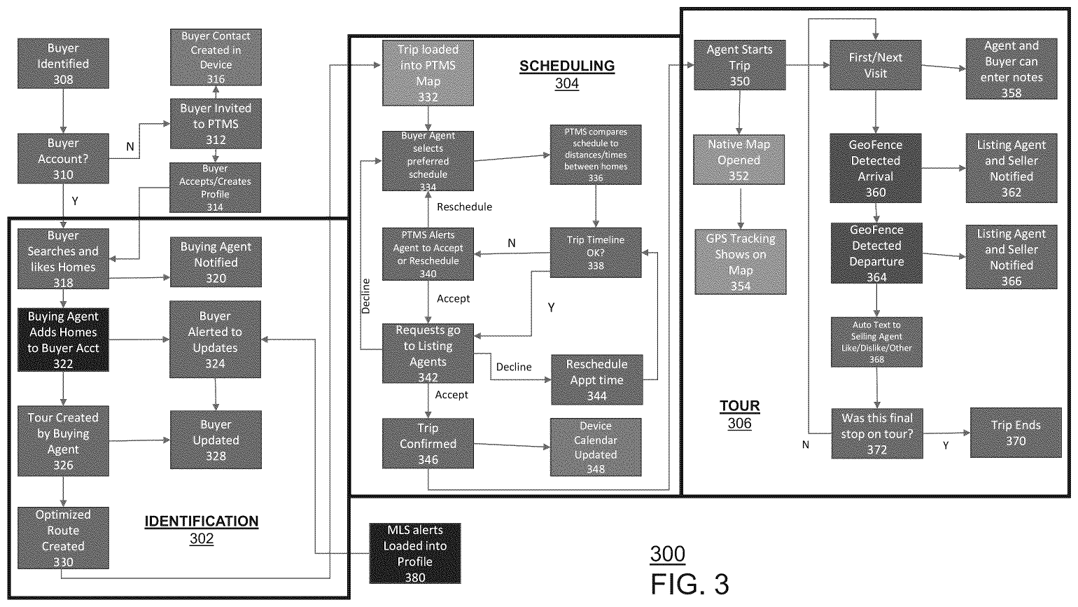

As shown in FIG. 3, this section describes an illustrative Property Tour Management System (“PTMS”) 300, which is exemplary of the PTMS described above in the Introduction and Overview above, but not the only embodiment of the PTMS in these teachings. PTMS 300 illustrates an embodiment designed to assist a residential real estate buying agent find and tour homes with his or her buyer.

In this example, PTMS 300 performs a plurality of steps that may include three main phases: the identification phase 302, the scheduling phase, 304, and the tour phase 306. One or more phases may be completed in whole or in part on one or several data processing systems, such as data processing system 100. One or more phases also may be completed on one or more computer networks, such as computer network 202.

Before the three main phases 302, 304, 306, the buying agent identifies a buyer 308. If the buyer does not have an account, the buying agent can invite 312 the buyer to create a profile on the property tour management system 314. When the buyer is invited 312, the illustrative PTMS 300 automatically may create a buyer contact profile on the buying agent's chosen device 316. Such device could be, for example, a MDD 214, a general purpose computer, or a special use computer.

In the identification phase 302, the buyer may search for and select homes to be included on the tour 318. A PTMS-enabled device may be utilized by the buyer to automatically include them in the PTMS tour profile, or they may be added to the profile later. Should the buyer use a PTMS-enabled device, the example PTMS 300 may automatically notify 320 the buying agent that the homes have been added to the buyer's profile. The buying agent may also search for and add homes 322 to the buyer's tour list. When the buying agent adds homes to the buyer's PTMS profile, the PTMS may automatically alert the buyer 324 that new homes have been added to their profile.

Many of the homes added may be listed in a multiple listing service (“MLS”). A PTMS may interface with an MLS, such as through computer network 200. When homes are added to the buyer's profile (318, 322) that are listed in an MLS with which PTMS 300 is networked (e.g. 200), the PTMS may automatically load MLS data into the buyer's profile 380. As explained in the definitions and introduction above, some MLS data is confidential information not to be disclosed to the buyer. When the PTMS loads MLS data onto the buyer's profile 380, it may permit the buying agent to see such confidential information while only permitting the buyer to see publicly available information. For example, the buyer may have a PTMS-enabled smartphone that displays only pictures of the home, its address, the listing price, nearby schools, crime rates, and local attractions while the buying agent is also permitted to see the listing agent's contact information and the seller's names and pictures.

When buyer and buying agent decide on a date for the tour, the buying agent may create a tour 326 by choosing the homes added to the buyer's profile (318, 322) that they will visit on the tour. The illustrated PTMS 300 automatically notifies the buyer that the buying agent is building a tour 328. When the tour is built, a PTMS may use the address information from the identified homes on the buyer's profile and, interfacing with an existing global positioning (“GPS”) and mapping service, optimize the tour route 330. Optimizing the tour route may be based on distance information from a starting point, expected traffic, etc. In some examples, the optimizing may use algorithms similar to map apps, such as Google® Maps.

In the scheduling phase 304, the optimized route 330 may be loaded onto the PTMS 300 GPS map and the PTMS may show the travel time between each location 332. A buying agent might use this information to decide on an appropriate schedule and enter the dates and times at which they wish to visit the home with their buyer 334. Once the buying agent is finished, PTMS 300 automatically compares the schedule to the distances and travel time between homes 336. If PTMS 300 detects that the trip schedule and travel times are in conflict 338, for example because the travel time between homes will run past the home tour time, it alerts the buying agent 340 of the flaw. For example, the PTMS 300 may assume an arrival date and time at the first home on the tour route is the same as the scheduled date and time. The PTMS may then assume a predetermined amount of time to visit the first home, such as 20, 30, or 40 minutes, to determine an estimated ending date and time. Alternatively, the visit time may be received from the buying agent or buyer for each property or for all properties. The PTMS may then add the estimated travel time to the second home on the tour route to the estimated ending time. If the sum or expected arrival date at the second home occurs after the scheduled date and time of the second home on the tour route, then the PTMS identifies a schedule conflict. The buying agent may then update the schedule 334 or accept the flawed version.

If no error was detected 338 or the buying agent accepts the flawed version 340, the illustrative PTMS notifies the listing agents of the proposed schedule 342. Each listing agent may accept or decline their scheduled tour 342. If a listing agent declines the tour appointment, the buying agent may reschedule that particular appointment 344 or redesign the schedule 334. All the features designed to assist the buying agent in scheduling the tour, route optimization 332, automatic trip time comparison 336, verification and alerts regarding trip feasibility 338, 340, and automatic requests sent to listing agents 342, are implemented again when rescheduling. Once a tour schedule is approved 346, the example PTMS 300 automatically updates the calendars of the buying and listing agents, the buyer, and the home seller 348 with their relevant appointment times.

Once the tour is started 350, the PTMS may provide a navigational function designs a navigational map 352 that displays the tour route and schedule. The map may also display estimated travel times and other information. The map also GPS tracks the buyer and buying agent 354 to provide automated step-by-step navigation to each stop on the tour. Once each location is visited, the map may update to remove information related to the homes already visited.

For each home on the tour, the PTMS may establish a virtual geographic perimeter around the property (known as a “geofence”), which may be a predetermined radius from the property (e.g., 1, 2, 5, or 10 miles) or may be based on input from the listing agent for each property. The PTMS may use GPS tracking to detect if the buyer or buying agent has entered the area inside the geofence perimeter 360 or crossed the geofence perimeter 360. PTMS 300 may then automatically notify the home seller and/or listing agent that the buyer and/or buying agent are arriving at the home 362. PTMS 300 may also detect when the buyer or buying agent then move outside of said geofence 364 after visiting the home and similarly notify the listing agent and/or home seller 366.

After each tour, the PTMS 300 may automatically prompt the selling agent inviting some form of feedback 368. For example, the selling agent may be sent a message asking for feedback on the experience in the form of a binary positive/negative that the PTMS then passes on to the buying agent. Alternatively, the prompt 368 could request feedback in a narrative or survey format. The PTMS 300 may also include functionality that allows a buyer, seller, buying agent, or listing agent to record information about the tour 358. For example, the buyer and buying agent may be able record notes about the property or rate the property on a scale.

If there are more homes to visit on the tour 372, the navigational functions 352, 354, geofence perimeter notifications 360, 362, 364, 366, information recording 358, and feedback prompt 368 may be repeated for each additional stop on the tour. Otherwise, the PTMS may terminate the tour 370 and provide final tour information to the parties involved. For example, the buyer and buying agent may receive a summary of notes and ratings they took on the tour. Although PTMS 300 is shown in FIG. 3 to perform particular steps, other examples of PTMS 300 may omit, replace, modify, duplicate, and/or add one or more steps. Additionally, the steps may be performed in any suitable sequence.

### D. Illustrative Combinations and Additional Examples

This section describes additional aspects and features of the PTMS, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A1. A method, implemented in a data processing system, the method comprising:
receiving, using a data processing system, one or more selected properties from a prospective buyer;
obtaining, using the data processing system, Multiple Listing Service (MLS) data associated with the one or more selected properties to the prospective buyer;
storing, using the data processing system, the obtained MLS data to a profile of the prospective buyer;
automatically notifying, using a communications unit of the data processing system, a buying agent of the prospective buyer regarding the one or more selected properties;
receiving, using the communications unit of the data processing system and from the buying agent, a tour selection of the one or more selected properties that will be toured;
automatically notifying, using the communications unit of the data processing system, the prospective buyer regarding the tour selection;
extracting, using the data processing system, addresses of the properties in the tour selection;
calculating, using the data processing system, an optimized route to visit the properties of the tour selection based on the addresses of the properties in the tour selection;
calculating, using the data processing system, one or more estimated travel times between properties in the tour selection based on the addresses of the properties in the tour selection;
displaying, using the data processing system, the calculated optimized route and the calculated one or more estimated travel times;
receiving, using the data processing system, proposed date and time for each of the properties in the tour selection;
identifying, using the data processing system, one or more conflicts between the received proposed date and time for each property in the tour selection and the calculated estimated travel times;
providing, using the data processing system, one or more notifications regarding the identified one or more conflicts;
notifying, using the communications unit of the data processing system, a listing agent of the proposed date and time associated with each property in the tour selection;
receiving, using the communications unit of the data processing system and from the listing agent of each property in the tour selection, acceptance or denial of the proposed date and time; and
notifying, using the communications unit of the data processing system, the buying agent or the prospective buyer of acceptance or denial of the proposed date and time for each property in the tour selection.
A2. The method of paragraph A1, wherein storing the obtained MLS data to a buyer's profile includes storing one or more non-confidential portions of the obtained MLS data to allow the prospective buyer to access the one or more non-confidential portions.
A3. The method of paragraph A2, wherein the non-confidential portions include at least one of pictures of the one or more selected properties, videos of the one or more selected properties, address of the one or more selected properties, a listing of nearby schools of the one or more selected properties, crime rates associated with neighborhoods of the one or more selected properties, or local attractions within a predetermined distance (e.g., 5 or 10 miles) of the one or more selected properties.
A4. The method of any of paragraphs A1-A3, wherein storing the obtained MLS data to a buyer's profile includes storing one or more confidential portions of the obtained MLS data such that the buyer agent can access the one or more confidential portions but the prospective buyer cannot access the one or more confidential portions.
A5. The method of paragraph A4, wherein the confidential portion includes at least one of listing agent's contact information associated with the one or more selected properties, names of the sellers of the one or more selected properties, or pictures of the sellers of the one or more selected properties.
A6. The method of any of paragraphs A1-A5, wherein identifying one or more conflicts between the received one or more proposed dates and times and the calculated estimated travel times includes determining, using the data processing system, whether a proposed date and time for a second property in the tour selection occurs before a proposed date and time for a first property that is upstream of the second property along the calculated optimized route.
A7. The method of any of paragraphs A1-A5, wherein identifying one or more conflicts between the received one or more proposed dates and times and the calculated estimated travel times includes:
calculating, using the data processing system, an estimated tour ending time for each property in the tour selection;
calculating, using the data processing system, an estimated arrival time at each property in the tour selection based on the estimated tour ending time of the previous property along the calculated optimized route and the calculated estimated travel time from the previous property; and
determining, using the data processing system, whether the estimated arrival time occurs after the proposed time and date for each property in the tour selection.
A8. The method of any of paragraphs A1-A7, further comprising displaying, using the data processing system, a navigational map showing the calculated optimized route and approved date and time for each property in the tour selection.

A9. The method of any of paragraphs A1-A8, further comprising:
tracking, using the data processing system, current location of the buying agent or the prospective buyer; and
displaying, using the data processing system, the current location on the navigational map.
A10. The method of any of paragraphs A1-A9, further comprising providing, using the data processing system, step-by-step navigation information to each property in the tour selection.
A11. The method of any of paragraphs A9-A10, further comprising notifying, using the communications unit of the data processing system, the listing agent when the current location of the buying agent or the prospective buyer is within a virtual geographic perimeter.
A12. The method of paragraph A11, further comprising receiving, using the data processing system, coordinates of the virtual geographic perimeter from the listing agent.
A13. The method of paragraph A11, wherein the virtual geographic perimeter is within a predetermined radius (e.g., 5 or 10 miles) from a property.
A14. The method of any of paragraphs A11-A13, further comprising notifying, using the communications unit of the data processing system, the listing agent when the current location of the buying agent or the prospective buyer is outside the virtual geographic perimeter.
A15. The method of any of paragraphs A11-A13, further comprising notifying, using the communications unit of the data processing system, the listing agent when the current location of the buying agent or the prospective buyer is outside the virtual geographic perimeter of a property along the navigational map after the approved date and time associated with that property.
A16. The method of any of paragraphs A1-A15, further comprising receiving, using the communications unit of the data processing system, feedback regarding each property along the navigational map.
B1. A data processing system for managing property tours, the system comprising:
a processor;
a memory; and
a property tour management program including a plurality of instructions stored in the memory and executable by the processor to:
receive one or more selected properties from a prospective buyer;
obtain Multiple Listing Service (MLS) data associated with the one or more selected properties to the prospective buyer;
store the obtained MLS data to a profile of the prospective buyer;
automatically notify a buying agent of the prospective buyer regarding the one or more selected properties;
receive, from the buying agent, a tour selection of the one or more selected properties that will be toured;
automatically notify the prospective buyer regarding the tour selection;
extract addresses of the properties in the tour selection;
calculate an optimized route to visit the properties of the tour selection based on the addresses of the properties in the tour selection;
calculate one or more estimated travel times between properties in the tour selection based on the addresses of the properties in the tour selection;
display the calculated optimized route and the calculated one or more estimated travel times;
receive a proposed date and time for each of the properties in the tour selection;
identify one or more conflicts between the received proposed date and time for each property in the tour selection and the calculated estimated travel times;
provide one or more notifications regarding the identified one or more conflicts;
notify a listing agent of the proposed date and time associated with each property in the tour selection;
receive, from the listing agent of each property in the tour selection, acceptance or denial of the proposed date and time; and
notify the buying agent or the prospective buyer of acceptance or denial of the proposed date and time for each property in the tour selection.
C1. A computer program product for managing property tours, the computer program product comprising:
a non-transitory computer-readable storage medium having computer-readable program code embodied therewith, the computer readable program code comprising:
at least one instruction to receive one or more selected properties from a prospective buyer;
at least one instruction to obtain Multiple Listing Service (MLS) data associated with the one or more selected properties to the prospective buyer;
at least one instruction to store the obtained MLS data to a profile of the prospective buyer;
at least one instruction to automatically notify a buying agent of the prospective buyer regarding the one or more selected properties;
at least one instruction to receive, from the buying agent, a tour selection of the one or more selected properties that will be toured;
at least one instruction to automatically notify the prospective buyer regarding the tour selection;
at least one instruction to extract addresses of the properties in the tour selection;
at least one instruction to calculate an optimized route to visit the properties of the tour selection based on the addresses of the properties in the tour selection;
at least one instruction to calculate one or more estimated travel times between properties in the tour selection based on the addresses of the properties in the tour selection;
at least one instruction to display the calculated optimized route and the calculated one or more estimated travel times;
at least one instruction to receive a proposed date and time for each of the properties in the tour selection;
at least one instruction to identify one or more conflicts between the received proposed date and time for each property in the tour selection and the calculated estimated travel times;
at least one instruction to provide one or more notifications regarding the identified one or more conflicts;
at least one instruction to notify a listing agent of the proposed date and time associated with each property in the tour selection;
at least one instruction to receive, from the listing agent of each property in the tour selection, acceptance or denial of the proposed date and time; and
at least one instruction to notify the buying agent or the prospective buyer of acceptance or denial of the proposed date and time for each property in the tour selection.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

What is claimed is:

1. A method, implemented in a data processing system, the method comprising:
receiving, using a data processing system, one or more selected properties from a prospective buyer;
obtaining, using the data processing system, Multiple Listing Service (MLS) data associated with the one or more selected properties to the prospective buyer;
storing, using the data processing system, the obtained MLS data to a profile of the prospective buyer;
automatically notifying, using a communications unit of the data processing system, a buying agent of the prospective buyer regarding the one or more selected properties;
receiving, using the communications unit of the data processing system and from the buying agent, a tour selection of the one or more selected properties that will be toured;
automatically notifying, using the communications unit of the data processing system, the prospective buyer regarding the tour selection;
extracting, using the data processing system, addresses of the properties in the tour selection;
calculating, using the data processing system, an optimized route to visit the properties of the tour selection based on the addresses of the properties in the tour selection;
calculating, using the data processing system, one or more estimated travel times between properties in the tour selection based on the addresses of the properties in the tour selection;
displaying, using the data processing system, the calculated optimized route and the calculated one or more estimated travel times;
receiving, using the data processing system, proposed date and time for each of the properties in the tour selection;
identifying, using the data processing system, one or more conflicts between the received proposed date and time for each property in the tour selection and the calculated estimated travel times;
providing, using the data processing system, one or more notifications regarding the identified one or more conflicts;
notifying, using the communications unit of the data processing system, a listing agent of the proposed date and time associated with each property in the tour selection;
receiving, using the communications unit of the data processing system and from the listing agent of each property in the tour selection, acceptance or denial of the proposed date and time; and
notifying, using the communications unit of the data processing system, the buying agent or the prospective buyer of acceptance or denial of the proposed date and time for each property in the tour selection.
